(19) United States
(12) Patent Application Publication
(10) Pub. No.: US 2008/0125189 A1
(43) Pub. Date: May 29, 2008

(54) RADIO COMMUNICATION APPARATUS AND POWER CONSUMPTION CONTROL METHOD OF RADIO COMMUNICATION APPARATUS

(75) Inventor: Ichiro Tomoda, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/858,084

(22) Filed: Sep. 19, 2007

(30) Foreign Application Priority Data
Nov. 29, 2006 (JP) 2006-322285

(51) Int. Cl. H04B 1/38

(52) U.S. Cl. 455/574

(57) ABSTRACT

According to one embodiment, a radio communication apparatus includes: a first radio communication device; a second radio communication device which is faster than the first radio communication device; a first switching control device raising gradually a communication speed with another radio communication apparatus, the communication using the first radio communication device, in accordance with congestion control of a transport protocol, and making the second radio communication device communicate with the another radio communication apparatus when the communication speed exceeds a predetermined threshold value; a second switching control device lowering the communication speed when the data communication of the second radio communication device reaches the congestion state and making the first radio communication device communicate with the another radio communication apparatus when the communication speed is under the threshold value; and a power control device making the second radio communication device be in a low power consumption mode when the communication speed is under the threshold value.

### CROSS-REFERENCE TO RELATED APPLICATIONS

This application is based upon and claims the benefit of priority from Japanese Patent Application No. 2006-322285, filed Nov. 29, 2006, the entire contents of which are incorporated herein by reference.

### BACKGROUND

1. Field

One embodiment of the invention relates to a radio communication apparatus and a power consumption control method of the radio communication apparatus.

2. Description of the Related Art

It is known that, in dial-up using a personal computer and a cellular phone to connect to internet, the personal computer and the cellular phone are connected by radio communication such as Bluetooth (registered trademark) without using an USB cable and the like. In a radio communication apparatus for short-distance such as a personal computer and a cellular phone, a radio communication capacity is desired to be large, and as a substitute of a Bluetooth method having a maximum communication speed of about 1 to 3 Mbps, an UWB (Ultra Wide Band) method having a maximum communication speed of about 20 to 400 Mpbs or over and a LAN (Local Area Network) method are being developed. In Patent Document 1, Japanese Patent Application Publication (KOKAI) No. 2002-271339, a radio communication apparatus using a wireless LAN system is described.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram showing a radio communication system using a radio communication apparatus according to an embodiment of the invention;

FIG. 2 is an exemplary block diagram showing a configuration of the radio communication apparatus according to the embodiment of the invention;

FIG. 3 is an exemplary graph showing transition of a communication speed by a congestion control processing of a data control section shown in FIG. 2 in the embodiment; and

FIG. 4 is an exemplary flowchart showing the congestion control processing and a power consumption control processing of the radio communication apparatus according to the embodiment of the invention.

### DETAILED DESCRIPTION

Various embodiments according to the invention will be described hereinafter with reference to the accompanying drawings. In general, according to one embodiment of the invention, a radio communication apparatus includes: a first radio communication device performing data communication by radio with another radio communication apparatus; a second radio communication device performing faster data communication than the first radio communication device with the another radio communication apparatus by radio; a first switching control device raising gradually a communication speed with the another radio communication apparatus, the communication using the first radio communication device, in accordance with congestion control of a transport protocol, and making the second radio communication device communicate with the another radio communication apparatus when the communication speed exceeds a predetermined threshold value; a second switching control device lowering the communication speed when the data communication of the second radio communication device reaches a congestion state and making the first radio communication device communicate with the another radio communication apparatus when the communication speed is under the threshold value; and a power control device making the second radio communication device be in a low power consumption mode when the communication speed is under the threshold value.

A power consumption control method of a radio communication apparatus includes: raising gradually a communication speed in data communication by radio with another radio communication apparatus, the data communication using a first radio communication device, in accordance with congestion control of a transport protocol, and communicating with the another radio communication apparatus by using a second radio communication device performing faster data communication than the first radio communication device by radio when the communication speed exceeds a predetermined threshold value; and lowering the communication speed when the data communication of the second radio communication device reaches a congestion state, and communicating with the another radio communication apparatus by using the first radio communication device and making the second radio communication device be in a low power consumption mode when the communication speed is under the threshold value.

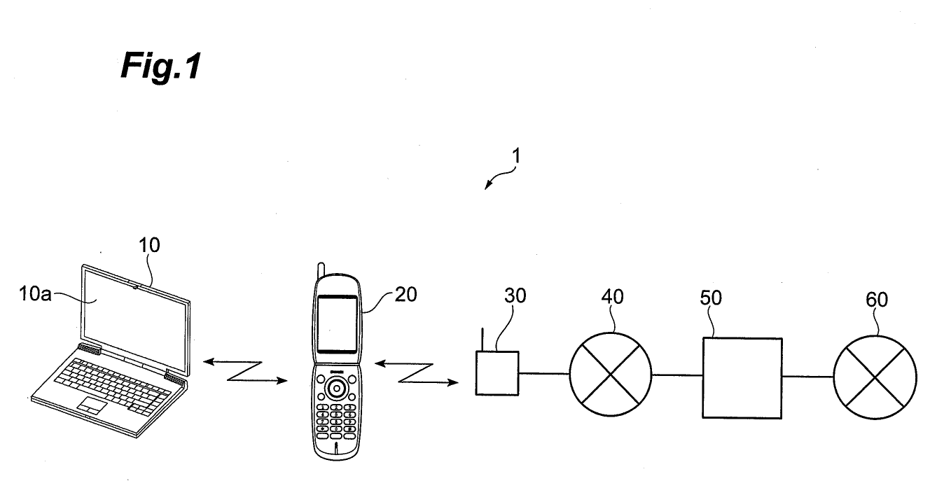

FIG. 1 is a diagram showing an example of a configuration of a radio communication system using a radio communication apparatus according to an embodiment of the invention. A radio communication system 1 shown in FIG. 1 includes a radio communication apparatus 10, a cellular phone 20, a base station 30, a telephone line network 40, an internet provider sever 50, and an internet network 60.

The radio communication apparatus 10 is a personal computer and is capable of performing dial-up connection to the internet network 60 via the base station 30, the telephone line network 40, and the internet provider server 50 by performing short-distance radio communication with the cellular phone 20 being another radio communication apparatus.

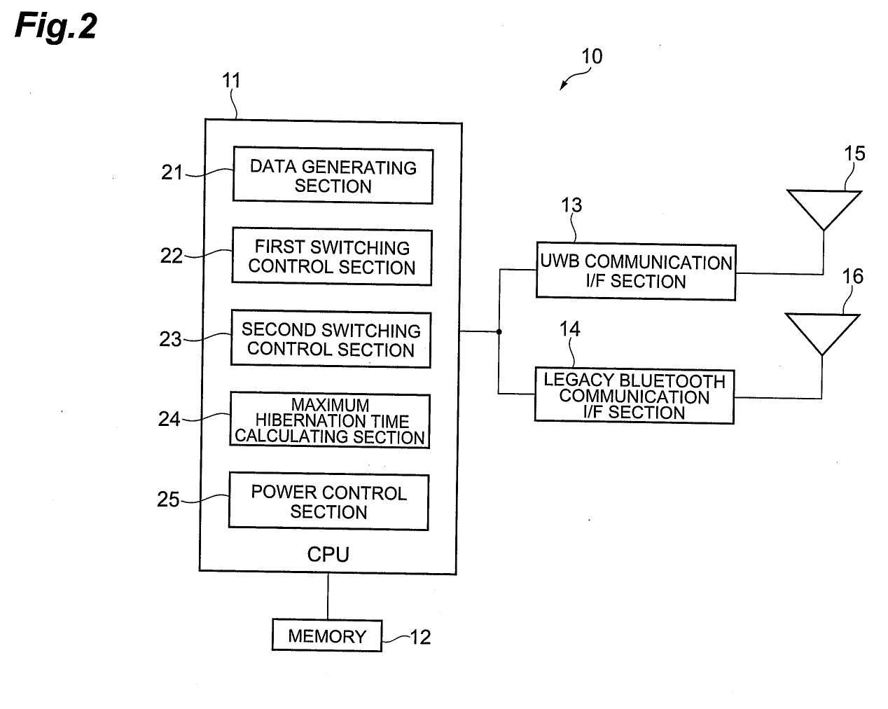

FIG. 2 is a block diagram showing a configuration of the radio communication apparatus 10. The radio communication apparatus 10 shown in FIG. 2 includes a CPU 11, a memory 12, an UWB communication I/F section (second radio communication device) 13, a Legacy-Bluetooth communication I/F section (first radio communication device: hereinafter, referred to as LegacyBT communication section) 14, and antennas 15, 16.

The CPU 11 functions as a data generating section 21, a first switching control section 22, a second switching control section 23, a maximum hibernation time calculating section 24, and a power control section 25, by executing various programs stored in the memory 12 or an auxiliary memory such as an unshown hard disc. Incidentally, in the memory 12, there are stored various programs to perform the above-described various functions.

The UWB communication I/F section 13 performs UWB communication with the cellular phone 20 via the antenna 15, while the LegacyBT communication I/F section 14 performs Legacy-Bluetooth communication with the cellular phone 20 via the antenna 16. Here, while a maximum communication speed of the LegacyBT communication I/F section 14 is about 1 to 3 Mbps, a maximum communication speed of the UWB communication I/F section 13 is about 20 to 400 Mbps or over, being faster than that of the LegacyBT communication I/F section 14. However, in general, a high-speed radio communication I/F section has large power consumption. The above-described UWB communication I/F section 13 is not an exception, and has larger power consumption than the LegacyBT communication I/F section 14. Incidentally, the UWB communication I/F section 13 and the LegacyBT communication I/F section 14 can use one common antenna.

The data generating section 21 generates data to transmit and delivers them to the first or second switching control section 22, 23.

The first and second switching control sections 22, 23 convert the data generated by the data generating section 21 to data for communication in accordance with a communication protocol, and output them to the UWB communication I/F section 13 or the LegacyBT communication I/F section 14. Further, the first and second switching control sections 22, 23 retrieve the data for communication from the cellular phone 20, from the UWB communication I/F section 13 or the LegacyBT communication I/F section 14, and convert the data to data suitable for output devices such as a liquid crystal display 10a in accordance with the communication protocol.

In the embodiment, a transport protocol of the communication protocol in the first and second switching control sections 22, 23 is a TCP (Transmission Control Protocol), while a network protocol is an IP (Internet Protocol). The TCP performs congestion control of the network 60, by control of a data communication speed (data rate) by window-based flow control.

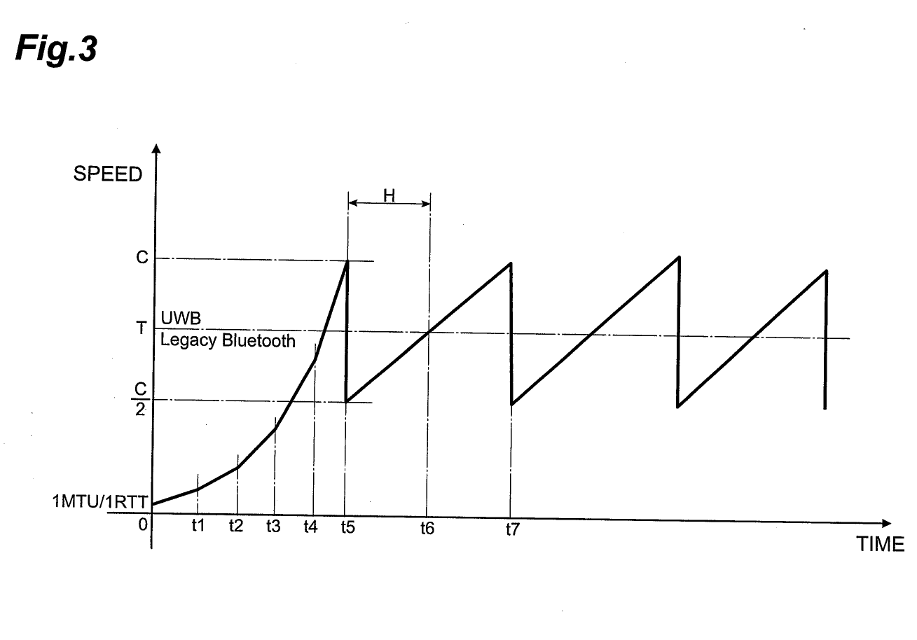

FIG. 3 is a graph showing transition of a communication speed by a congestion control processing of the first and second switching control sections 22, 23. As shown in FIG. 3, specifically, during times t0 to t5, the first switching control section 22 starts data communication at a low communication speed at the beginning and gradually raises the communication speed with doubling the speed per later-described every RTT (Round Trip Time) in accordance with congestion control of the TCP, whereby performs slow start. Hereby, the first control section 22 prevents occurrence of congestion of the networks 40, 60. As for the second switching control section 23, in a case of a congestion state (time t5) in which the communication speed is large for capacities of the networks 40, 60 and packet discard (packet loss) occurs in the networks 40, 60, the second switching control section 23 promotes recovery from the congestion state by halving the communication speed in accordance with the congestion control of the TCP. After the time t5, the first switching control section 22 increases the speed by 1 MTU (Maximum Transmission Unit) per 1 RTT, whereby the first switching control section 22 gradually raises the communication speed. On this occasion, when the congestion occurs, the second switching control section 23 halves the speed, and thereafter the first switching control section 22 and the second switching control section 23 function repeatedly.

The communication protocols in the first and second switching control sections 22, 23 are WiMedia MAC specification. In the WiMedia MAC specification, there is prescribed a hibernation mode (inactive state) in which a power source of the UWB communication I/F section 13 is cut off for a predetermined time.

The maximum hibernation time calculating section 24 calculates a maximum hibernation time H of the hibernation mode by a maximum hibernation time calculating formula shown in a below-described formula (1)

H=(T−C/2)/(MTU/RTT) (1)

Here, “T” denotes a threshold value of a communication speed for switching between data communication by the UWB communication I/F section 13 and data communication by the LegacyBT communication section I/F section 14, and is set at or under a maximum communication speed at which the LegacyBT communication I/F section 14 is able to communicate. “C” denotes a communication speed at a time that the networks 40, 60 become in the congestion states. “MTU” denotes a maximum size of the communication packet transmittable in one transmission, while “RTT” denotes a time from transmission of the data to reception of a response of ACK (Acknowledgement).

The first switching control section 22 switches from the data communication by the LegacyBT communication I/F section 14 to the data communication by the UWB communication I/F section 13 when the communication speed exceeds the threshold value T, in the congestion control of the TCP.

The second switching control section 23 switches from the data communication by the UWB communication I/F section 13 to the data communication by the LegacyBT communication I/F section 14 when the communication speed is under the threshold value T, in the congestion control of the TCP. Specifically, the second switching control section 23 continues the data communication by the UWB communication I/F section 13 if the maximum hibernation time H is zero or a negative value, and switches from the data communication by the UWB communication I/F section 13 to the data communication by the LegacyBT communication I/F section 14 if the maximum hibernation time H is a positive value.

The power control section 25 makes the UWB communication I/F section 13 be in a low power consumption mode when the communication speed is under the threshold value T. Specifically, when the maximum hibernation time H is a positive value, the power control section 25 makes the UWB communication I/F section 13 be in a hibernation mode during the maximum hibernation time H.

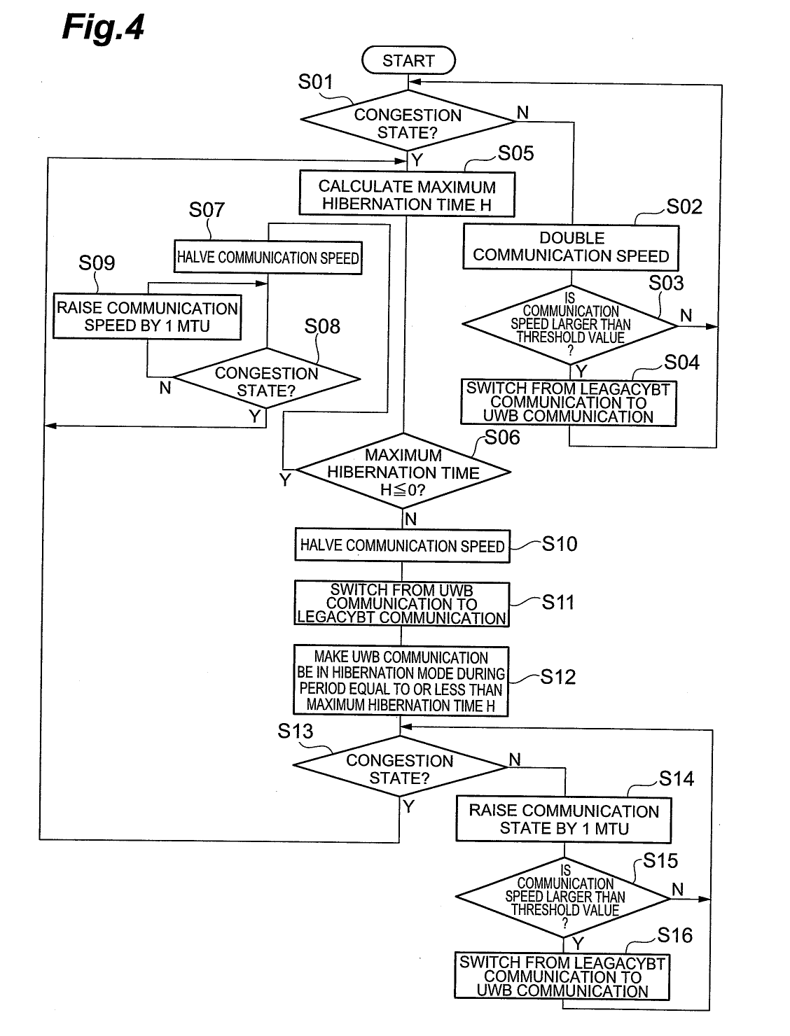

Next, using FIG. 3 and FIG. 4, an operation of the radio communication apparatus 10 will be described and a power consumption control method of a radio communication apparatus according to an embodiment of the invention will be described. FIG. 4 is a flowchart showing a congestion control processing and a power consumption control processing of the radio communication apparatus 10.

First, the CPU 11 reads the various programs stored in the memory 12, whereby the CPU 11 functions as the data generating section 21 and generates data. Thereafter, the CPU 11 functions as the first and second switching control sections 22, 23 and converts the data to the data for communication in accordance with the communication protocol. On this occasion, the congestion control of the networks 40, 60 is performed in the TCP of the communication protocol.

As shown in FIG. 3, the first switching control section 22 sets the communication speed at 1 MTU/1 RTT at the beginning, and makes the LegacyBT communication I/F section 14 operate to transmit the data for communication. Thereafter, the first switching control section 22 gradually accelerates from a low communication speed until the time t5 (slow-start function), whereby the first switching control section 22 prevents occurrence of the congestion of the networks 40, 60.

Specifically, the first switching control section 22 performs congestion state judgment of whether or not the networks 40, 60 reach the congestion states by whether or not the ACK can be received (S01). If the ACk can be received, the first switching control section 22 judges that the networks 40, 60 do not reach the congestion states and doubles the communication speed at the time t1 (S02).

Thereafter, the first switching control section 22 performs communication speed judgment of whether or not the communication speed is larger than the threshold value T (S03). If the communication speed is equal to or lower than the threshold value T, the first switching control section returns to S0. On the other hand, if the communication speed is larger than the threshold value T, the first switching control section 22 switches from the communication by the LegacyBT communication I/F section 14 to the communication by the UWB communication I/F section 13 (S04), and thereafter returns to S01.

In S01, if the ACK cannot be received, the first switching control section 22 judges that the networks 40, 60 reach the congestion states. Then, the second switching control section 23 promotes recovery from the congestion state by decreasing the speed (time t5) and thereafter, during times t5 to t7, prevents occurrence of congestion of the networks 40, 60 by gradually increasing the speed.

Specifically, the CPU 11 functions as the maximum hibernation time calculating section 24 and calculates the maximum hibernation time H by the above-described formula (1) (S05). Thereafter, the second switching control section 23 performs communication speed judgment similar to that of the first switching control section 22 described above, by whether positive or negative the calculated maximum hibernation time H is (S06). If the calculated maximum hibernation time H is zero or a negative value, the second switching control section 23 judges that the communication speed is larger than the threshold value T and halves the communication speed (corresponding to the time t5), but does not perform operation switching and continues the data communication by the UWB communication I/F section 13 (S07).

Thereafter, similarly to in S01, while performing acceleration, the first switching control section 22 performs congestion state judgment by whether or not the ACK can be received (S08). If the ACK can be received, the first switching control section 22 judges that the networks 40, 60 do not reach the congestion states, and increases the communication speed by 1 MTU per 1 RTT (S09), and returns to S08.

On the other hand, in S08, if the ACK cannot be received, the first switching control section 22 judges that the networks 40, 60 reach the congestion states and returns to S05, and deceleration and acceleration by the second switching control section 23 described above are repeated so that a recovery processing from the congestion state is repeated (corresponding to the time t7 and after).

In S06, if the calculated maximum hibernation time H is a positive value, the second switching control section 23 judges that the communication speed is under the threshold value T, and halves the communication speed at the time t5 (S10) and switches from the communication by the UWB communication I/F section 13 to the communication by the LegacyBT communication I/F section 14 (S11). Further, the CPU 11 functions as the power control section 25 and makes the UWB communication I/F section 13 be in the hibernation mode during the maximum hibernation time H (S12).

As stated above, during the maximum hibernation time H of FIG. 3, that is, a period from the time t5 to a time t6 at which the communication speed reaches the threshold value T again, even without using the high-speed UWB communication I/F section 13, the communication is quite possible by the low-speed LegacyBT communication I/F section 14, and so the power control section 25 makes the UWB communication I/F section 13 be in a halt state during a period until the time t6 at which the high-speed UWB communication I/F section 13 is required again.

Thereafter, similarly to in S01, the first switching control section 22 performs congestion state judgment by whether or not the ACK can be received (S13). If the ACK can be received, the first switching control section 22 judges that the networks 40, 60 do not reach the congestion states, and increases the communication speed by 1 MTU per 1 RTT from the times t5 to t6. (S14). Thereafter, similarly to in S03, the first switching control section 22 performs communication speed judgment (S15). If the communication speed does not reach the threshold value, the first switching control section 22 returns to S13, and if the communication speed reaches the threshold value, the switching control section 22 switches from the data communication by the LegacyBT communication I/F section 14 to the data communication by the UWB communication I/F section 13 at the time t6 (S16) and thereafter returns to S13.

In S13, if the ACK cannot be received, the first switching control section 22 judges that the networks 40, 60 reach the congestion states, and returns to S05, so that deceleration and acceleration by the second switching control section 23 are repeated again, the recovery from the congestion state being repeated (on and after the time t7).

As stated above, according to the radio communication apparatus of the embodiment, the high-speed communication is possible by using the UWB communication I/F section 13. Additionally, if the communication speed is under the threshold value T by the congestion control of the TCP, even without using the high-speed UWB communication I/F section 13, communication is quite possible by the low-speed LegacyBT communication I/F section 14. Therefore, the communication is performed by using the LegacyBT communication I/F section 14, which consumes less power than the UWB communication I/F section 13, instead of the UWB communication I/F section 13, and the UWB communication I/F section 13 is made to be in the hibernation mode (low power consumption mode). Hereby, lowering of power consumption is possible.

Further, since the time of the hibernation mode of the UWB communication I/F section 13 is set to be the maximum hibernation time H obtained by the threshold value T, the communication speed C at which the data communication reaches the congestion state, MTU, and RTT, it is possible to adequately perform switching between a Legacy Bluetooth link and a UWB link in synchronization with the congestion control of the TCP. Therefore, by lowering the UWB link to in the hibernation mode (low power consumption mode) until this switching timing arrives, the UWB link is not used more than necessary so that the power consumption can be lowered.

It should be noted that the invention is not limited to the above-described embodiment and various changes are possible. For example, the invention can be applicable to a case that the high-speed communication device and the low-speed communication device are not the UWB communication I/F section or the LegacyBT communication I/F section respectively, a case that the transport protocol is not the TCP, or a case that the specification is not WiMediaMAC. Further, for example, the threshold value T can be adjusted in correspondence with a communication radio wave condition or a sound speech condition of the cellular phone 20.

Further, in the embodiment, the power control section 25 sets the period of the hibernation mode to be the maximum hibernation time H calculated by the above-described formula (1), but the period of the hibernation mode can be equal to or less than the maximum hibernation time H. If the period of the hibernation mode is smaller than the maximum hibernation time H, the power source of the UWB communication I/F section 13 is turned on before the communication speed reaches the threshold value T. Therefore, switching from the data communication by the LegacyBT communication I/F section 14 to the data communication by the UWB communication I/F section 13 is performed smoothly.

Further, in the embodiment, switching from the data communication by the LegacyBT communication I/F section 14 to the data communication by the UWB communication I/F section 13 is performed at the time that the communication speed reaches the threshold value T, but the switching can be performed at a time that the hibernation mode of the UWB communication I/F section 13 ends.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A radio communication apparatus comprising:
a first radio communication device configured to perform data communication by radio with a separate radio communication apparatus;
a second radio communication device configured to perform faster data communication by radio with said separate radio communication apparatus than said first radio communication device;
a first switching control device configured to gradually raise a communication speed with the separate radio communication apparatus, the communication using said first radio communication device, in accordance with congestion control of a transport protocol, and making said second radio communication device communicate with the separate radio communication apparatus when the communication speed exceeds a predetermined threshold value;
a second switching control device configured to lower the communication speed when the data communication of said second radio communication device reaches the congestion state and making said first radio communication device communicate with the separate radio communication apparatus when the communication speed is under the threshold value; and
a power control device making said second radio communication device be in a low power consumption mode when the communication speed is under the threshold value.

2. The radio communication apparatus according to claim 1, wherein the low power consumption mode in said second radio communication device comprises a hibernation mode.

3. The radio communication apparatus according to claim 2, further comprising a maximum hibernation time calculating device configured to calculate a maximum hibernation time in the hibernation mode using a formula based on a communication speed in the congestion state, the threshold value, a maximum transmission unit size in a communication line, and a round trip time in the communication line, and wherein said power control device is configured to make said second radio communication device be in the hibernation mode during a period equal to or less than the maximum hibernation time calculated by said maximum hibernation time calculating device when the communication speed is under the threshold value.

4. A radio communication apparatus comprising:
a first radio communication device configured to perform data communication by radio with a separate radio communication apparatus;
a second radio communication device configured to perform faster data communication by radio with the separate radio communication apparatus than said first radio communication device;
a first switching control device configured to gradually raise a communication speed with the separate radio communication apparatus, the communication using said first radio communication device, in accordance with congestion control of a transport protocol, and making said second radio communication device communicate with the separate radio communication apparatus when a hibernation mode of said second radio communication device ends;
a second switching control device configured to lower the communication speed when data communication of said second radio communication device reaches the congestion state, and making said first radio communication device communicate with the separate radio communication apparatus when the communication speed is under the threshold value;
a power control device configured to make said second radio communication device be in the hibernation mode during a period equal to or less than a maximum hibernation time when the communication speed is under the threshold value; and
a maximum hibernation time calculating device configured to calculate the maximum hibernation time in the hibernation mode using a maximum hibernation time calculating formula based on a communication speed in the congestion state, the threshold value, a maximum transmission unit size in a communication line, and a round trip time in the communication line.

5. The radio communication apparatus according to claim 3, wherein said second switching control device and said power control device are configured to judge that the communication speed is under the threshold value when the maximum hibernation time calculated by said maximum hibernation time calculating device is a positive value.

6. The radio communication apparatus according to claim 4, wherein said second switching device and said power control device are configured to judge that the communication speed is under the threshold value when the maximum hibernation time calculated by the maximum hibernation time calculating device is a positive value.

7. The radio communication apparatus according to claim 1, wherein the threshold value is set to be equal to or lower than a maximum communication speed of said first radio communication device.

8. The radio communication apparatus according to claim 4, wherein the threshold value is set to be equal to or lower than a maximum communication speed of said first radio communication device.

9. The radio communication apparatus according to claim 1, wherein the transport protocol is a Transport Control Protocol (TCP).

10. The radio communication apparatus according to claim 4, wherein the transport protocol is a Transport Control Protocol (TCP).

11. The radio communication apparatus according to claim 1, wherein said second radio communication device is configured to perform Ultra Wide Band (UWB) communication while said first radio communication device is configured to perform Bluetooth communication.

12. The radio communication apparatus according to claim 4, wherein said second radio communication device is configured to perform Ultra Wide Band (UWB) communication while said first radio communication device is configured to perform Bluetooth communication.

13. A power consumption control method of a radio communication apparatus comprising:
raising gradually a communication speed in data communication by radio with a separate radio communication apparatus, the data communication using a first radio communication device, in accordance with congestion control of a transport protocol, and communicating with the separate radio communication apparatus by using a second radio communication device that is configured to perform faster data communication than the first radio communication device when the communication speed exceeds a predetermined threshold value; and
lowering the communication speed when the data communication of the second radio communication device reaches a congestion state, and communicating with the separate radio communication apparatus by using the first radio communication device and making the second radio communication device be in a low power consumption mode when the communication speed is under the threshold value.
